(19) United States
(12) Patent Application Publication
(10) Pub. No.: US 2025/0376321 A1
(43) Pub. Date: Dec. 11, 2025

(54) Waste Bin Device

(71) Applicant: Zara Habte, Willingboro, NJ (US)

(72) Inventor: Zara Habte, Willingboro, NJ (US)

(21) Appl. No.: 18/737,184

(22) Filed: Jun. 7, 2024

(51) Int. Cl. B65F 1/00; B65F 1/06; B65F 1/16

(52) U.S. Cl. CPC B65F 1/0033; B65F 1/06; B65F 1/163; B65F 1/1646; B65F 2001/1676; B65F 2210/167

(57) ABSTRACT

A waste bin device for discreet disposal of feminine hygiene products includes a bin having an interior space that is designed to receive a trash bag to store trash. A bin opening extends into the interior space of the bin. A lid is pivotably coupled to the bin and is positionable to cover the bin opening. A pedal is coupled to the bin and to the lid wherein the pedal is actuatable to position the lid to expose the bin opening. A seal extends across the bin opening. The seal is made from a rubber material wherein the seal is designed to inhibit airflow outwardly from the interior space and wherein the seal is 10 designed to inhibit odors from trash stored within the trash bag from diffusing outwardly from the bin. A drawer coupled to the bin is designed to store a plurality of sanitary products.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to garbage can and more particularly pertains to a new garbage can for discreet disposal of feminine hygiene products.

### (2) Description of Related Art Including Information Disclosed Under 37 CFR 1.97 and 1.98

The prior art relates to garbage cans. There are many types of garbage cans. Some are large, some are small. For example, some restrooms have small garbage cans positioned in each stall where people can dispose of menstrual hygiene products such as tampons and maxi pads. Other restrooms will have larger garbage cans positioned near the sinks or doors, where people can dispose of menstrual hygiene products along with other garbage, such as paper towels. Used menstrual hygiene products may have an odor. The smell of the used menstrual hygiene products can make it more difficult for people to discreetly dispose of the products. Thus, there is a need for a garbage can that is sealed to inhibit odors from the trash from escaping the garbage can. Such a device would also ideally be designed for hands-free use, because such devices would commonly be placed in bathrooms with a relatively high concentration of germs and bacteria. Such a device would also ideally include a compartment for storing additional menstrual hygiene products so that people can access them as needed.

### BRIEF SUMMARY OF THE INVENTION

An embodiment of the disclosure meets the needs presented above by generally comprising a bin having an interior space that is configured to receive a trash bag wherein the bin is configured to store trash within the trash bag. A bin opening extends into the interior space of the bin. A lid is pivotably coupled to the bin. The lid is positionable to selectively cover and expose the bin opening. A pedal is coupled to the bin. The pedal is couped to the lid wherein the pedal is actuatable to position the lid to selectively cover and expose the bin opening. A seal is coupled to the bin. The seal extends across the bin opening. The seal comprises a rubber material wherein the seal is configured to inhibit airflow outwardly from the interior space and wherein the seal is configured to inhibit odors from trash stored within the trash bag from diffusing outwardly from the bin. A drawer is coupled to the bin. The drawer is configured to store a plurality of sanitary products.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a front isometric view of a waste bin device according to an embodiment of the disclosure.

FIG. 2 is a front isometric view of an embodiment of the disclosure.

FIG. 3 is a side view of an embodiment of the disclosure.

FIG. 4 is a rear view of an embodiment of the disclosure.

FIG. 5 is a cross-sectional view of an embodiment of the disclosure.

FIG. 6 is a cross-sectional view of an embodiment of the disclosure.

FIG. 7 is a front isometric view of an embodiment of the disclosure.

### DETAILED DESCRIPTION OF THE INVENTION

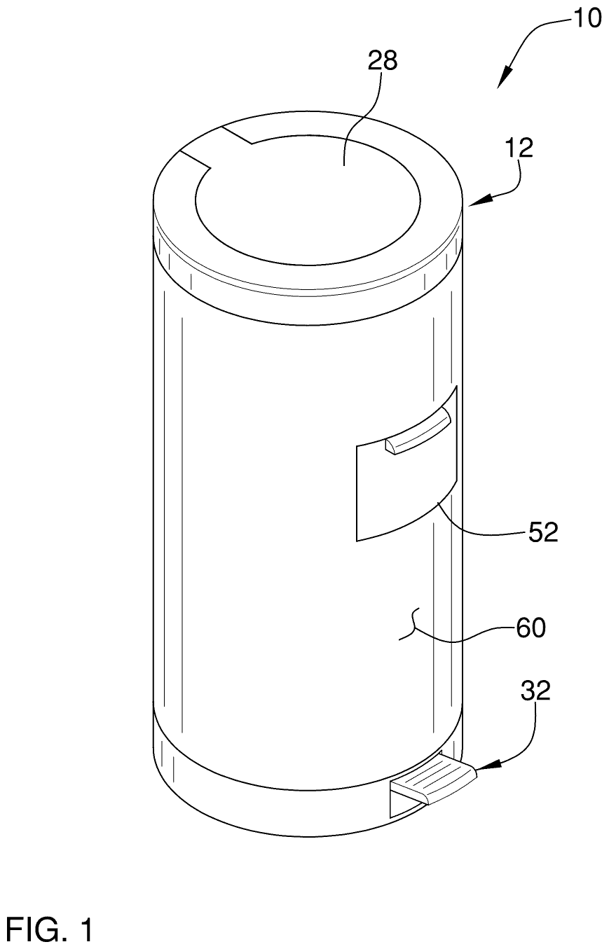

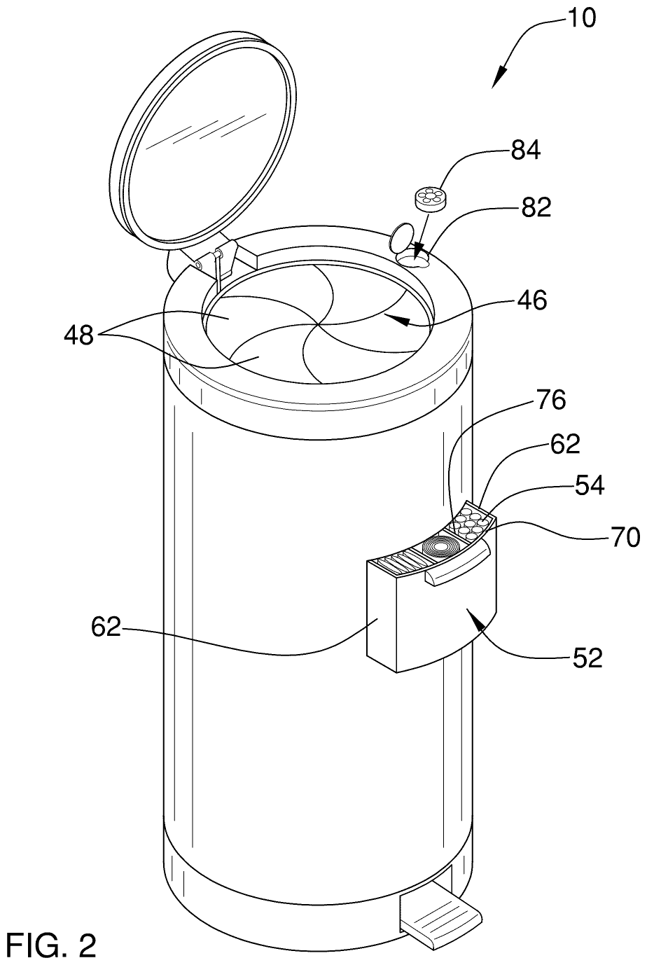

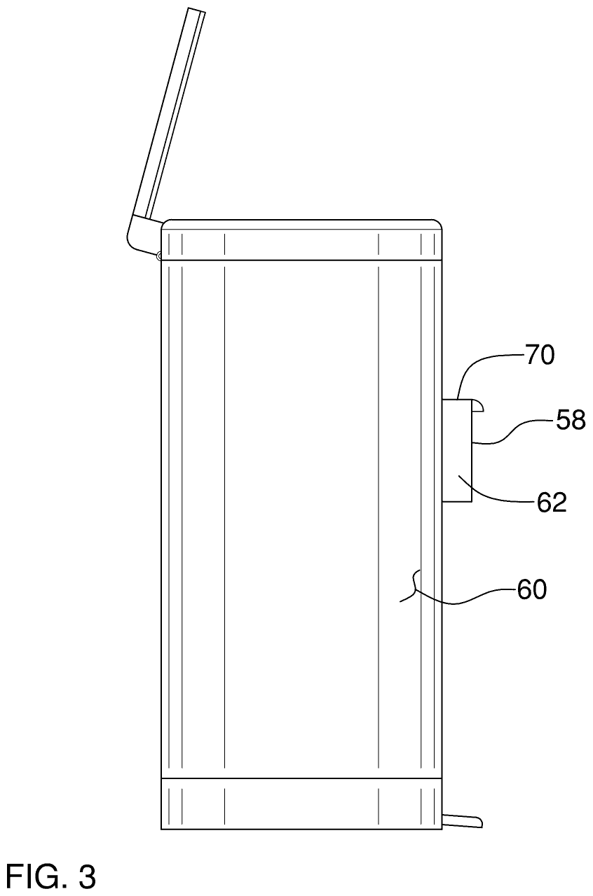

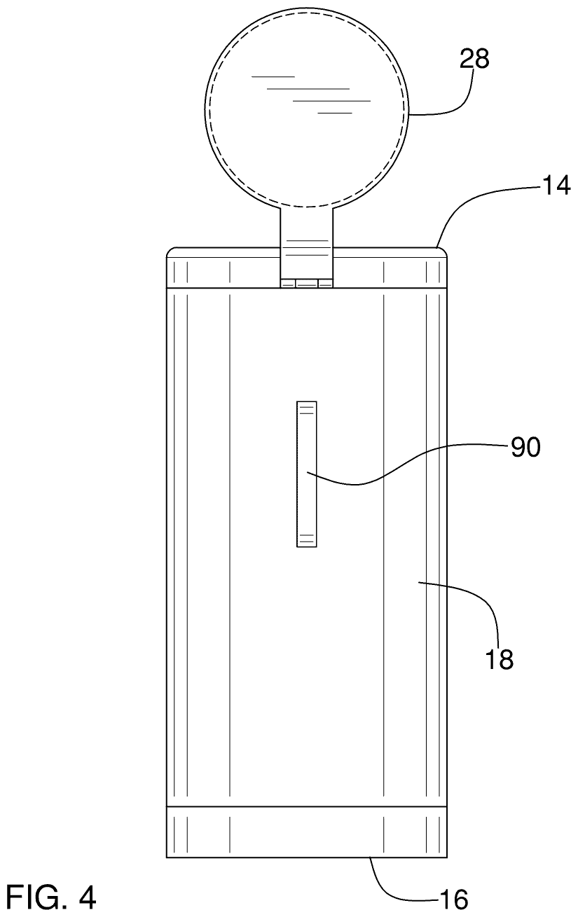

With reference now to the drawings, and in particular to FIGS. 1 through 7 thereof, a new garbage can embodying the principles and concepts of an embodiment of the disclosure and generally designated by the reference numeral 10 will be described.

As best illustrated in FIGS. 1 through 7, the waste bin device 10 generally comprises a bin 12. The bin 12 generally has an interior space 20 which may be defined by a top wall 14, a bottom wall 16, and a peripheral wall 18 that is coupled to and extends between the top wall 14 and the bottom wall 16. The interior space 20 is configured to receive a trash bag 22 wherein the bin 12 is configured to store trash 24 within the trash bag 22. The trash bag 22 may be scented wherein the trash bag 22 is configured to reduce, inhibit, or cover up odors from the trash 24. The bin 12 may be cylindrical. The bin 12 may have a height between 20.0 inches and 35.0 inches wherein the bin 12 is configured to be discreetly positionable in a bathroom.

A bin opening 26 extends through the top wall 14 into the interior space 20 of the bin 12. The bin opening 26 may be centrally positioned on the top wall 14. The bin opening 26 may be circular.

A lid 28 is pivotably coupled to the bin 12. The lid 28 is positionable to selectively cover and expose the bin opening 26. The lid 28 may generally have an inner surface 30 that faces the bin opening 26 when the lid 28 is positioned to cover the bin opening 26.

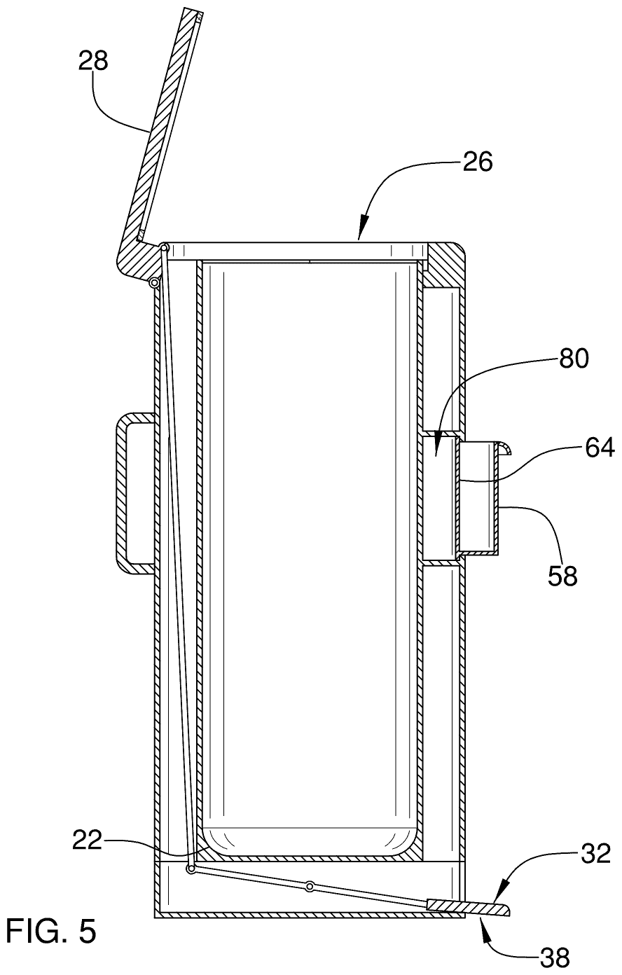

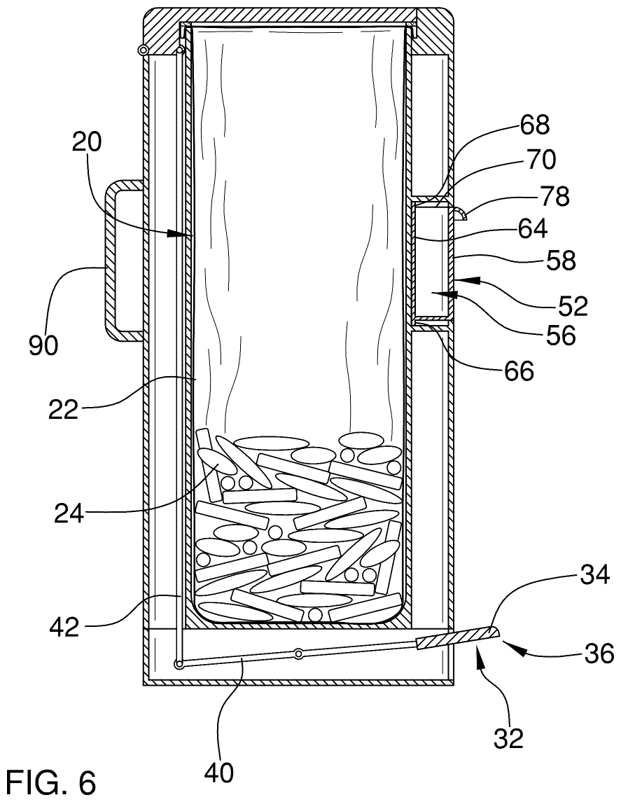

A pedal 32 is coupled to the bin 12. The pedal 32 is couped to the lid 28. The pedal 32 is actuatable to position the lid 28 to selectively cover and expose the bin opening 26. For example, manipulation of the pedal 32 may raise the lid 28 to expose the bin opening 26 and may lower the lid 28 to cover the bin opening 26, as shown in FIGS. 5 and 6.

The pedal 32 may include a plate 34 that extends outwardly from the peripheral wall 18 of the bin 12. The plate 34 may be positioned proximate to the bottom wall 16 wherein the plate 34 is configured for manipulation by a foot of a user. The plate 34 may be pivotable between an elevated position 36 and a depressed position 38 wherein pressure on the plate 34 lowers the plate 34 into the depressed position 38. The plate 34 may be in physical contact with the bottom wall 16 when the plate 34 is in the depressed position 38. The plate 34 may pivot into the elevated position 36 when pressure is removed from the plate 34. The plate 34 may be angled to extend upwardly from the bottom wall 16 and outwardly from the peripheral wall 18 when the plate 34 is in the elevated position 36.

A leg 40 may be coupled to the plate 34. The leg 40 may extend outwardly from the plate 34. The leg 40 may be positioned in the interior space 20 adjacent to the bottom wall 16. An arm 42 may be pivotably coupled to the leg 40. The arm 42 may extend upwardly from the leg 40 to the lid 28. The leg 40 may urge the arm 42 upwards when the plate 34 is pivoted downward to the depressed position 38 wherein application of pressure on the plate 34 lifts the lid 28 to expose the bin opening 26. The leg 40 may urge the arm 42 downwards when the plate 34 is pivoted upward to the elevated position 36 wherein removal of pressure from the plate 34 lowers the lid 28 to cover the bin opening 26.

A gasket 44 may be coupled to the lid 28. The gasket 44 may be positioned on a perimeter edge of the inner surface 30 of the lid 28. The gasket 44 may comprise a rubber material wherein the gasket 44 is configured to seal 46 a junction between the bin 12 and the lid 28 when the lid 28 is positioned over the bin opening 26. The gasket 44 may inhibit airflow outwardly from the interior space 20 to inhibit odors from trash 24 stored within the trash bag 22 from diffusing outwardly from the bin 12.

A seal 46 is coupled to the bin 12. The seal 46 generally extends across the bin opening 26. The seal 46 may comprise a rubber material wherein the seal 46 is configured to inhibit airflow outwardly from the interior space 20 and wherein the seal 46 is configured to inhibit odors from trash 24 stored within the trash bag 22 from diffusing outwardly from the bin 12. The gasket 44 may be in physical contact with the seal 46 when the lid 28 is positioned to cover the bin opening 26.

The seal 46 may include a plurality of leaves 48 that is pivotably coupled to an inside surface of the peripheral wall 18. The plurality of leaves 48 may extend outwardly from the inside surface of the peripheral wall 18 to a center of the bin opening 26. The plurality of leaves 48 may intersect with one another at the center of the bin opening 26 wherein the plurality of leaves 48 is positioned to cover the bin opening 26. The plurality of leaves 48 may be positioned adjacent to the top wall 14.

The plurality of leaves 48 may be pivotable downwardly wherein the plurality of leaves 48 is configured to allow the user to deposit trash 24 into the trash bag 22 through the plurality of leaves 48. For example, the rubber material may be flexible, wherein each leaf of the plurality of leaves 48 is flexible downwardly when pressure is applied to each leaf of the plurality of leaves 48 to deposit trash 24 into the trash bag 22. Each leaf of the plurality of leaves 48 may be flexible upwardly when pressure is removed from each leaf of the plurality of leaves 48 after the user has deposited trash 24 into the trash bag 22. The plurality of leaves 48 may be perpendicular to the peripheral wall 18 of the bin 12 when pressure is removed from each leaf of the plurality of leaves 28.

A drawer 52 is coupled to the bin 12. The drawer 52 has a drawer interior 56 that is configured to store a plurality of sanitary products 54. For example, the drawer 52 may store menstrual hygiene products such as tampons, max pads, and menstrual cup. The drawer 52 may also store additional trash bags or other cleaning supplies.

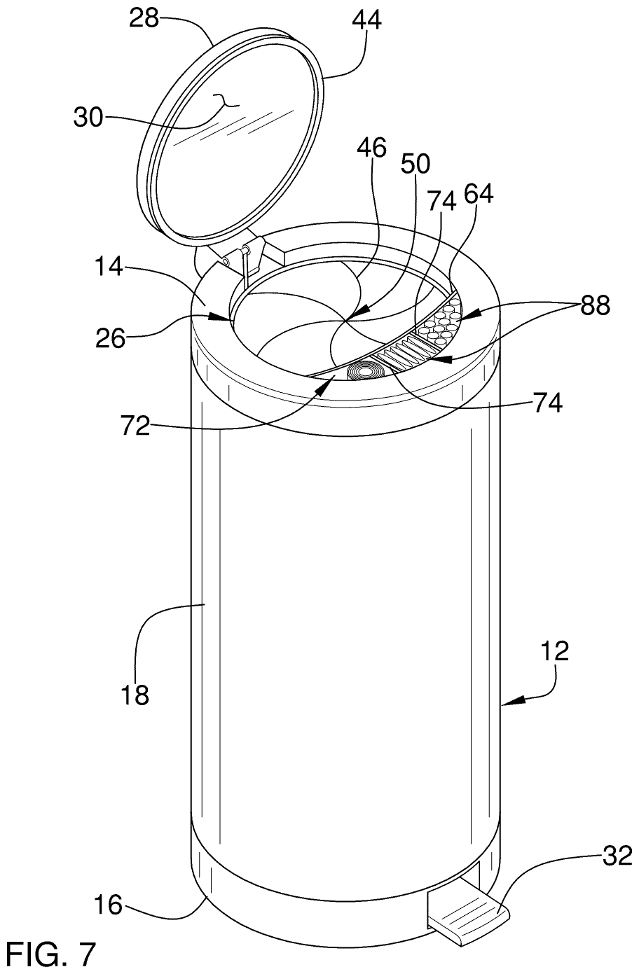

In embodiments according to FIG. 7, the drawer 52 may be positioned within the interior space 20. For example, the drawer 52 may be positioned adjacent to the top wall 14 wherein the drawer interior 56 is exposed when the lid 28 is positioned to expose the bin opening 26 and wherein the drawer 52 is covered when the lid 28 is positioned to cover the bin opening 26. The drawer 52 is generally positioned above the seal 46 wherein the drawer 52 is configured to be accessible to the user when the lid 28 is opened and when the seal 46 is closed. The drawer 52 may have a drawer rear wall 64 that is spaced from top wall 14 of the bin 12. The drawer rear wall 64 may be arcuate. The drawer rear wall 64 may have a drawer upper edge 70 that is coplanar with an outer edge of the bin opening 26. A pair of drawer dividers 74 may be coupled to and extend between the top wall 14 of the bin 12 and the drawer rear wall 64. The pair of drawer dividers 74 are generally spaced from each other to define a plurality of drawer sections 88 within the drawer interior 56. The plurality of drawer sections 88 are generally configured to facilitate organization of the sanitary products 54 stored within the drawer 52.

In embodiments according to FIGS. 1-3 and 5-6, the drawer 52 may be slidably coupled to the peripheral wall 18 wherein the drawer 52 is slidable outwardly from the peripheral wall 18 to expose the drawer interior 56. For example, the drawer 52 may include a drawer front wall 58. The drawer front wall 58 is generally coplanar with an outer surface 60 of the peripheral wall 18 of the bin 12 when the drawer 52 is fully closed. The drawer front wall 58 may be arcuate wherein the drawer front wall 58 is flush with the outer surface 60 of the peripheral wall 18 when the drawer 52 is fully closed.

A pair of drawer lateral walls 62 may be coupled to and extend outwardly from the drawer front wall 58. The pair of drawer lateral walls 62 may be perpendicular to the drawer front wall 58. The pair of drawer lateral walls 62 may be parallel to each other.

In such embodiments, the drawer rear wall 64 may be coupled to and extend between the pair of drawer lateral walls 62. The drawer rear wall 64 may be positioned against the peripheral wall 18 of the bin 12 when the drawer 52 is fully opened wherein the drawer interior 56 is fully exposed when the drawer 52 is fully opened. The drawer rear wall 64 may be arcuate between the pair of drawer lateral walls 62.

A lower lip 66 may be coupled to and extend downwardly from the drawer rear wall 64. The lower lip 66 may be coplanar with the drawer rear wall 64. The lower lip 66 may abut the peripheral wall 18 when the drawer 52 is fully opened to inhibit the drawer 52 from being decoupled or removed from the peripheral wall 18.

An upper lip 68 may be coupled to and extend upwardly from the drawer rear wall 64. The upper lip 68 may be coplanar with the drawer rear wall 64. The upper lip 68 may be aligned with the lower lip 66 across the drawer rear wall 64. The upper lip 68 may abut the peripheral wall 18 when the drawer 52 is fully opened to inhibit the drawer 52 from being decoupled, or removed, from the peripheral wall 18.

Each of the drawer front wall 58 and the pair of drawer lateral walls 62 may have the drawer upper edge 70. The drawer upper edge 70 defines a drawer opening 72 into the drawer interior 56.

The pair of drawer dividers 74 may be coupled to and extend between the drawer front wall 58 and the drawer rear wall 64 to define the plurality of drawer sections 88 within the drawer interior 56. Each drawer 52 divider of the pair of drawer dividers 74 may have a divider top edge 76 that is coplanar with the drawer upper edge 70. The pair of drawer dividers 74 is generally spaced from each other. The pair of drawer dividers 74 may be parallel to each other. The pair of drawer dividers 74 may be parallel to the pair of drawer lateral walls 62.

A drawer handle 78 may be coupled to the drawer 52. The drawer handle 78 may extend outwardly from the drawer front wall 58. The drawer handle 78 is generally configured to facilitate the user in sliding the drawer 52 outwardly and inwardly relative to the peripheral wall 18 to selectively open and close the drawer 52.

A recess 80 may extend into the peripheral wall 18 of the bin 12. The recess 80 generally has a shape that is complementary to the drawer 52 wherein the recess 80 is configured to receive the drawer 52.

A cutout 82 may extend into the top wall 14. The cutout 82 is generally configured to receive a deodorizer pod such as an ARM 42 & HAMMER® deodorizing ball, a CLOROX® air freshening gel, a BATH & BODY WORKS® SCENTPORTABLE® disc, or a similar non-electric freshener product. The deodorizer pod may be scented or may have a chemical composition configured to reduce or eliminate odors from trash 24 that diffuse outwardly from the bin 12 through the gasket 44 and the seal 46. The cutout 82 may be positioned adjacent to the bin opening 26.

A bin handle 90 may be coupled to the bin 12. For example, the bin handle 90 may be positioned on the peripheral wall 18, as shown in FIG. 6. In other embodiments, the bin handle 90 may be positioned on the top wall 14, or may be coupled to the lid 28. The bin handle 90 generally extends outwardly from the bin 12 wherein the bin handle 90 is configured to facilitate the user in lifting and transporting the bin 12.

In use, the pedal 32 may be used to open and close the lid 28. Trash 24 can be deposited into the trash bag 22 through the seal 46. The seal 46 and the gasket 44 inhibit airflow outwardly from the interior space 20 of the bin 12, reducing odors from the trash 24. To further inhibit odors from the trash 24, the trash bag 22 may be scented and the deodorizer pod may be positioned within the cutout 82. The drawer 52 provides a convenient storage space for sanitary products or other items, such as additional deodorizer pods and trash bags.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A waste disposal assembly comprising:
a bin having an interior space being configured to receive a trash bag wherein the bin is configured to store trash within the trash bag;
a bin opening extending into the interior space of the bin;
a lid being pivotably coupled to the bin, the lid being positionable to selectively cover and expose the bin opening;
a pedal being coupled to the bin, the pedal being couped to the lid wherein the pedal is actuatable to position the lid to selectively cover and expose the bin opening;
a seal being coupled to the bin, the seal extending across the bin opening, the seal comprising a rubber material wherein the seal is configured to inhibit airflow outwardly from the interior space and wherein the seal is configured to inhibit odors from trash stored within the trash bag from being diffused outwardly from the bin; and
a drawer being coupled to the bin, the drawer being configured to store a plurality of sanitary products.

2. The waste disposal assembly of claim 1, wherein the drawer is positioned within the interior space wherein the drawer is exposed when the lid is positioned to expose the bin opening and wherein the drawer is covered when the lid is positioned to cover the bin opening.

3. The waste disposal assembly of claim 2, wherein the drawer is positioned above the seal wherein the drawer is configured to be accessible to a user when the lid is opened and when the seal is closed.

4. The waste disposal assembly of claim 1, wherein the drawer is slidably coupled to the bin wherein the drawer is slidable outwardly from a peripheral wall of the bin to expose a drawer interior of the drawer.

5. The waste disposal assembly of claim 4, the drawer further comprising:
a drawer front wall being coplanar with an outer surface of the peripheral wall of the bin when the drawer is fully closed;
a pair of drawer lateral walls being coupled to and extending outwardly from the drawer front wall; and
a drawer rear wall being coupled to and extending between the pair of drawer lateral walls.

6. The waste disposal assembly of claim 5, wherein the bin is cylindrical and wherein the drawer front wall is arcuate wherein the drawer front wall is flush with the outer surface of the peripheral wall when the drawer is fully closed.

7. The waste disposal assembly of claim 5, wherein the pair of drawer lateral walls is perpendicular to the drawer front wall.

8. The waste disposal assembly of claim 5, wherein the drawer rear wall is positioned against the peripheral wall of the bin when the drawer is fully opened wherein the drawer interior is fully exposed when the drawer is fully opened.

9. The waste disposal assembly of claim 5, wherein the drawer rear wall is arcuate between the pair of drawer lateral walls.

10. The waste disposal assembly of claim 5, the drawer further comprising a pair of drawer dividers being coupled to and extending between the drawer front wall and the drawer rear wall to define a plurality of drawer sections within the drawer interior.

11. The waste disposal assembly of claim 10, wherein each of the drawer front wall and the pair of drawer lateral walls have a drawer upper edge defining a drawer opening into the drawer interior, each drawer divider of the pair of drawer dividers having a divider top edge being coplanar with the drawer upper edge.

12. The waste disposal assembly of claim 10, wherein the pair of drawer dividers are spaced from each other.

13. The waste disposal assembly of claim 10, wherein the pair of drawer dividers are parallel to each other.

14. The waste disposal assembly of claim 5, the drawer further comprising a lower lip being coupled to and extending downwardly from the drawer rear wall, the lower lip abutting the peripheral wall when the drawer is fully opened to inhibit the drawer from being decoupled from the peripheral wall.

15. The waste disposal assembly of claim 5, the drawer further comprising an upper lip being coupled to and extending upwardly from the drawer rear wall, the upper lip abutting the peripheral wall when the drawer is fully opened to inhibit the drawer from being decoupled from the peripheral wall.

16. The waste disposal assembly of claim 1, further comprising a cutout extending into the bin wherein the cutout is configured to receive a deodorizer pod.

17. The waste disposal assembly of claim 1, the seal further comprising a plurality of leaves being pivotably coupled to an inside surface of the bin, the plurality of leaves extending outwardly from the inside surface of the bin to a center of the bin opening, the plurality of leaves intersecting with one another at the center of the bin opening wherein the plurality of leaves is positioned to cover the bin opening, the plurality of leaves being pivotable wherein the plurality of leaves is configured to allow a user to deposit trash into the trash bag through the plurality of leaves.

18. The waste disposal assembly of claim 1, further comprising a gasket being coupled to the lid, the gasket comprising a rubber material wherein the gasket is configured to seal a junction between the bin and the lid when the lid is positioned over the bin opening to inhibit airflow outwardly from the interior space and wherein the gasket is configured to inhibit odors from trash stored within the trash bag from being diffused outwardly from the bin.

19. A waste disposal assembly comprising:
a bin having a top wall, a bottom wall, and a peripheral wall being coupled to and extending between the top wall and the bottom wall to define an interior space, the interior space being configured to receive a trash bag wherein the bin is configured to store trash within the trash, the bin being cylindrical, the bin having a height between 20.0 inches and 35.0 inches;
a bin opening extending through the top wall into the interior space of the bin, the bin opening being centrally positioned on the top wall;
a lid being pivotably coupled to the bin, the lid being positionable to selectively cover and expose the bin opening, the lid having an inner surface, the inner surface facing the bin opening when the lid is positioned to cover the bin opening;
a pedal being coupled to the bin, the pedal being couped to the lid wherein the pedal is actuatable to position the lid to selectively cover and expose the bin opening, the pedal including:
a plate extending outwardly from the peripheral wall of the bin, the plate being positioned proximate to the bottom wall wherein the plate is configured for manipulation by a foot of a user, the plate being pivotable between an elevated position and a depressed position wherein pressure on the plate lowers the plate into the depressed position, the plate being in physical contact with the bottom wall when the plate is in the depressed position, the plate pivoting into the elevated position when pressure is removed from the plate, the plate being angled to extend upwardly from the bottom wall and outwardly from the peripheral wall when the plate is in the elevated position;
a leg being coupled to the plate, the leg extending outwardly from the plate, the leg being positioned in the interior space adjacent to the bottom wall;
an arm being pivotably coupled to the leg, the arm extending upwardly from the leg to the lid, the leg urging the arm upwards when the plate is pivoted downward to the depressed position wherein application of pressure on the plate lifts the lid to expose the bin opening, the leg urging the arm downwards when the plate is pivoted upward to the elevated position wherein removal of pressure from the plate lowers the lid to cover the bin opening;
a gasket being coupled to the lid, the gasket being positioned on a perimeter edge of the inner surface of the lid, the gasket comprising a rubber material wherein the gasket is configured to seal a junction between the bin and the lid when the lid is positioned over the bin opening to inhibit airflow outwardly from the interior space and wherein the gasket is configured to inhibit odors from trash stored within the trash bag from being diffused outwardly from the bin;
a seal being coupled to the bin, the seal extending across the bin opening, the seal comprising a rubber material wherein the seal is configured to inhibit airflow outwardly from the interior space and wherein the seal is configured to inhibit odors from trash stored within the trash bag from being diffused outwardly from the bin, the gasket being in physical contact with the seal when the lid is positioned to cover the bin opening, the seal including:
a plurality of leaves being pivotably coupled to an inside surface of the peripheral wall, the plurality of leaves extending outwardly from the inside surface of the peripheral wall to a center of the bin opening, the plurality of leaves intersecting with one another at the center of the bin opening wherein the plurality of leaves is positioned to cover the bin opening, the plurality of leaves being positioned adjacent to the top wall, the plurality of leaves being pivotable downwardly wherein the plurality of leaves is configured to allow the user to deposit trash into the trash bag through the plurality of leaves;
a drawer being coupled to the bin, the drawer having a drawer interior being configured to store a plurality of sanitary products, the drawer being slidably coupled to the peripheral wall wherein the drawer is slidable outwardly from the peripheral wall to expose the drawer interior, the drawer including:
a drawer front wall being coplanar with an outer surface of the peripheral wall of the bin when the drawer is fully closed, the drawer front wall being arcuate wherein the drawer front wall is flush with the outer surface of the peripheral wall when the drawer is fully closed;
a pair of drawer lateral walls being coupled to and extending outwardly from the drawer front wall, the pair of drawer lateral walls being perpendicular to the drawer front wall, the pair of drawer lateral walls being parallel to each other;
a drawer rear wall being coupled to and extending between the pair of drawer lateral walls, the drawer rear wall being positioned against the peripheral wall of the bin when the drawer is fully opened wherein the drawer interior is fully exposed when the drawer is fully opened, the drawer rear wall being arcuate between the pair of drawer lateral walls;
a lower lip being coupled to and extending downwardly from the drawer rear wall, the lower lip being coplanar with the drawer rear wall, the lower lip abutting the peripheral wall when the drawer is fully opened to inhibit the drawer from being decoupled from the peripheral wall;
an upper lip being coupled to and extending upwardly from the drawer rear wall, the upper lip being coplanar with the drawer rear wall, the upper lip being aligned with the lower lip across the drawer rear wall, the upper lip abutting the peripheral wall when the drawer is fully opened to inhibit the drawer from being decoupled from the peripheral wall;
each of the drawer front wall and the pair of drawer lateral walls having a drawer upper edge defining a drawer opening into the drawer interior; and
a pair of drawer dividers being coupled to and extending between the drawer front wall and the drawer rear wall to define a plurality of drawer sections within the drawer interior, each drawer divider of the pair of drawer dividers having a divider top edge being coplanar with the drawer upper edge, the pair of drawer dividers being spaced from each other, the pair of drawer dividers being parallel to each other, the pair of drawer dividers being parallel to the pair of drawer lateral walls;
a drawer handle being coupled to the drawer, the drawer handle extending outwardly from the drawer front wall wherein the drawer handle is configured to facilitate the user in sliding the drawer outwardly and inwardly relative to the peripheral wall;
a recess extending into the peripheral wall of the bin, the recess having a shape being complementary to the drawer wherein the recess is configured to receive the drawer; and
a cutout extending into the top wall wherein the cutout is configured to receive a deodorizer pod, the cutout being positioned adjacent to the bin opening.
